(19) United States
(12) Patent Application Publication
(10) Pub. No.: US 2019/0295429 A1
(43) Pub. Date: Sep. 26, 2019

(54) System and Method for displaying personalized interactive and/or instructive data

(71) Applicants: Steven M. McHugh, Killingworth, CT (US); Sean McKirdy, Newington, CT (US)

(72) Inventors: Steven M. McHugh, Killingworth, CT (US); Sean McKirdy, Newington, CT (US)

(21) Appl. No.: 14/181,331

(22) Filed: Feb. 14, 2014

Related U.S. Application Data
(60) Provisional application No. 61/764,956, filed on Feb. 14, 2013.

(51) Int. Cl. G09B 5/06

(52) U.S. Cl. CPC G09B 5/06

(57) ABSTRACT

A method for interacting with a person via a virtual image is provided and includes sensing at least one of, a physical characteristic of the person, and an environmental characteristic of an environment proximate the person; generating at least one of an image and a sound responsive to the sensing; and communicating at least one of the image and the sound to the person.

### RELATED APPLICATIONS

This application claims the benefit of priority of the filing date of U.S. Provisional Patent Application Ser. No. 61/764,956 filed Feb. 14, 2013, the content of which is incorporated by reference herein in its entirety.

### FIELD OF THE INVENTION

The present invention relates generally to interactive media and more particularly to a instructive interactive media using personal devices.

### BACKGROUND OF THE INVENTION

There are many industries that are overcome with the challenges of engaging consumers and potential customers. A staple for various industries has been to focus on the development of phone based or tablet based solutions that will help bridge the gap between the content that companies want to push to consumers with the hope that they will develop the ‘killer app’ that will set them apart from their competition. Smartphones have been able to help drive the creation of a more ‘connected’ world with their ability to deliver access to content virtually anywhere and anytime. However, while mobile devices such as Smartphones and Tablets have gained ground, they are also hindered by limitations on how the hardware devices can be used in various real world situations and environments as it relates to how content is viewed and interacted with.

For example, a person at the gym must constantly take their mobile device out of their pocket to view a phone app that might have their workout routine, then take it out again to enter the data back into their phone app for tracking purposes when working out on strength equipment. This requires constant interaction with a hardware device in order to gain access to content or to provide feedback based on their performance. Another example might be a person who uses their mobile device (smartphone/tablet/etc) as part of a cardio exercise machine workout where the mobile device is in communication with the cardio machine for purposes of tracking workout results, programming the cardio machine with existing workout routines found on mobile device, and/or providing media based content and messaging that can be displayed and interacted with on the cardio machine display or associated add on TV screen type display screens. When a person is using a cardio machine, for example a treadmill, their smartphone might have the ability to allow them to change the control, operation, and display of the cardio machine. Having to change machine settings and machine operations while using an exercise machine can interrupt a person's exercise experience, and possibly cause injury when attempting to lean forward to press control buttons on the machine display (touch screen or keypad interfaces) while they are moving.

Another example might be person who chooses to exercise without exercise equipment, whether inside or outside of a gym, and does one of the popular exercise programs like ‘P90X’ or ‘Jillian Michaels Workout’ that requires the person to be either in front of a TV or a computer with a DVD player, DVR or VCR. If that person is sharing the display screen with family members, they would have a very hard time trying to follow that program while their kids or spouse were watching TV or on the computer, or even if they were in a hotel room that might not have a DVD player or VCR. Additionally, while this type of exercise content can be displayed on a smartphone, the person would have a hard time following instructions if they were constantly having to take their media player content device out of their pocket or off of their arm band to view the content.

Still yet another example might be a person who is watching television or even a movie inside a movie theater. The content that is displayed directly to the individual person is also being shared by the millions of other viewers of the same channel or movie screen. There is no current method that allows the viewing experience to be personalized for a specific person while viewing content in a shared environment, such as watching TV in a living room or a movie in a movie theater.

### SUMMARY OF THE INVENTION

A method for interacting with a person via a virtual image is provided and includes sensing at least one of, a physical characteristic of the person, and an environmental characteristic of an environment proximate the person; generating at least one of an image and a sound responsive to the sensing; and communicating at least one of the image and the sound to the person.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike in the several FIGURES:

FIG. 1 is an operational block diagram illustrating a method interacting with a person via a virtual image, in accordance with one embodiment of the invention.

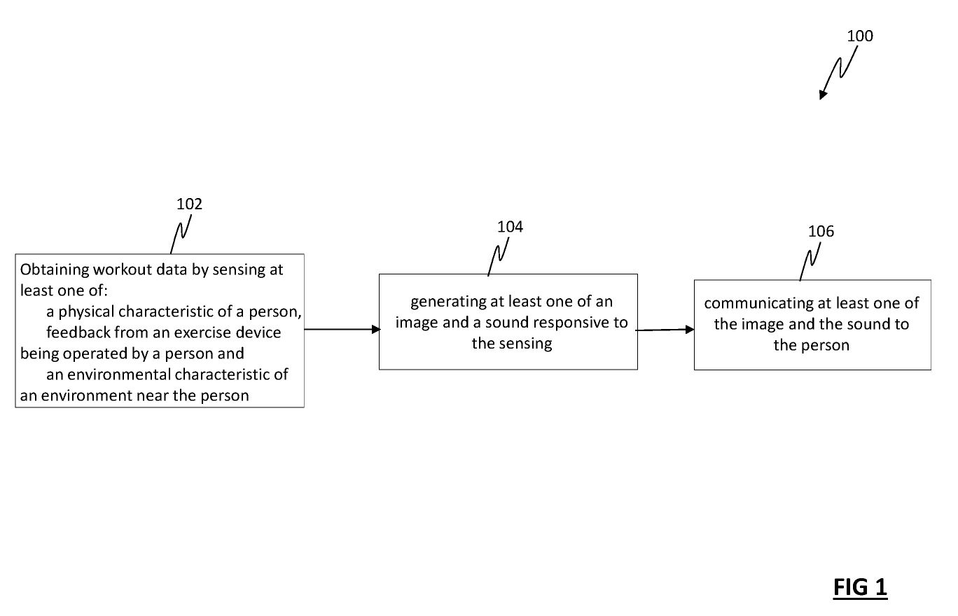

### DETAILED DESCRIPTION OF THE INVENTION

It should be appreciated that the present invention provides a solution that allows a person to interact with personalized and instructive media that is displayed by the use of a wearable display device (such as Google Goggles/Google Glass type devices) and/or sensors that may be able to detect bio-metrics of the user and/or also working in combination with sensed environmental conditions, objects, and machines around the user via sensors on the wearable device. For example, the wearable device could be comprised of a head mounted frame with a camera, a touch pad interface used for scrolling and selecting (like a mouse works on a computer), while also having processing and data transmission capabilities (wired and wireless). The bio-metric sensors can be fully embedded into the wearable device, partially embedded, or be part of external hardware the user is wearing or also be part of a machine/device the user is using (exercise machine, health monitoring system, etc) and can include (but not be limited to) heart rate sensors, body fat sensors, sweat sensors, blood glucose sensors, body temperature sensors, accelerometer, pulse oximeter, blood pressure, etc.

It is contemplated that the sensors in the wearable device that may be used to detect environmental conditions or objects around a person can be, but are not limited to, wireless radio transceivers such as Bluetooth/Wifi/NFC/RFID, optics (such as those found in mobile devices used for scanning or taking pictures or videos), GPS, cellular, fingerprint sensors, etc. Additionally, the wearable display device may be capable of having at least one of or all of the bio-metric and environmental sensor types housed inside itself. Moreover, at least some or all of the sensors can be housed inside a peripheral device that is in signal communication with the wearable device (such as a mobile device, smartphone, tablet, smartwatch like the Basis Band or the Pebble, fitness tracker device like a FitBit, etc). For example, a person wearing the wearable display device glasses may be able to display information or media might also have a mobile device such as an iPhone or Android that may contain at least some of the sensor capabilities of the invention such as GPS, cellular that may be able to provide location sensed information that might contribute to the type of content or instructive media that is displayed to the person. This may allow the person to use other devices such as mobile devices as ‘sensor hubs’.

In the example of a person that is working out in a gym, outside, or at home using the wearable device, the wearable display device may be able to detect and display in real time to the person on the wearable device's display, a person's heart rate, sweat level, movement using accelerometer devices or also be able to communicate with exercise equipment (or peripheral devices that are in communication with exercise equipment such as CSAFE based hardware modules) and display the information captured from the exercise machine onto the heads up display of the wearable device during an exercise session. In a scenario where the user's wearable device is communicating with an exercise machine, the display of the wearable device may be capable of showing machine data and user performance data as part of the heads up display, allowing the user to look around or possibly use alternate display settings of the machine while still being able to have real-time access to their workout performance data. An example of the type of data that might be displayed to a user on their wearable device display screen may be machine type, distance, calories burned, heart rate, pace, cadence, program type, speed, incline, resistance, stride, channel setting, volume setting, TV/Media information, etc.

Another example of how a user experience during an exercise session on an exercise machine can be improved by using the wearable device is how guidance on how to use the exercise machine can be displayed to the user via the display of the wearable device. The wearable device can detect the type of machine using various sensors (camera based sensors for image detection on the machine, wireless/wired connectivity for detecting machine information, scanning a barcode/QR code or AR marker/augmented reality based image recognistion on the machine, etc) Once the machine type is detected either by the wearable device or by a smartphone/tablet that is in communication with the wearable device, the guidance content can be displayed to the user on the wearable device display (heads up display element). This content can be videos on how to start and operate the machine, instructions on how to navigate menus and interfaces on the machine, instructions on when to press the speed up/down, incline up/down, resistance up/down buttons on the machine that may be based on a workout routine specific to the user that is located on the wearable device or the user's mobile device. The content can be interactive with the system where a user is messaged on their wearable display to press ‘Quickstart’ on a exercise machine, and when the user presses a button on the machine (for example, a ‘QuickStart’ button), the wearable device is receiving signals from the exercise machine regarding the software state data of the machine along with exercise data which may be used to trigger a next set of guidance content for the user which is then displayed on the user's wearable device display.

Additionally, the wearable device may also have a integrated touchpad as part of the wearable device assembly. Since the wearable device and the exercise machine may be in bi-directional communication, the user might also be able to control the exercise machine display and operation via the integrated touchpad of the wearable device. The user may be able to control the display screen of the exercise machine via swiping gestures remotely through the wearable device touchpad, select individual icons/apps on the exercise machine remotely through the wearable device touchpad, control the operation of the speed, incline, resistance, TV/Video/Audio/Media controls, etc of the machine during an exercise session through the wearable device touchpad, access operational/maintenance menus of the exercise machine, change the channel and volume or media input selection through the wearable device touchpad. It should be appreciated that the touchpad of the wearable device may be a combination of a touchpad sensor, a button or combination of buttons, a touchscreen interface, include a microphone for speech based controls that can also be used for controlling the machine as described above, or a combination of some or all of these touchpad variations.

The system described above can also provide a solution for reducing costs of how exercise machines are manufactured by eliminating the need for costly machine control interfaces such as consoles that are used traditionally to control the exercise machine. The wearable device (with or without the use of a mobile device such as a smartphone) can have the ability to allow a person using an exercise machine to control the exercise machine and provide full feedback to the person on the exercise machine. The person's wearable device in this embodiment may be able to run a software application that was capable of controlling the exercise machine and may be in bi-directional communication with the machine. For example, a treadmill might have all of the control electronics assembled near the base of the unit, and might only have safety rails for the user of the machine. Once a person were to approach the treadmill, they may initiate the start and stop of the machine and operation of the machine entirely from the interface of their heads up display using one of the many sensors configurations previously described.

The person might also have a Smartphone that might be running a phone app that is responsible for both sending and receiving data from the wearable display device. In this scenario, a person may be able to keep their Smartphone in their pocket or attached to their arm via an armband and have the wearable display device display information on the lens of the wearable display device that only the user may be able to see. This information could be any one of their bio-metrics such as real time heart rate, calories burned, exercise program information, message from a gym trainer, text message icon from their mobile device, social media feeds from their mobile device, etc. This invention may be able to analyze the real time performance of a person during an exercise routine, and display feedback to the user by giving the user multiple metrics to view through the display of their wearable display device without having to constantly lock and unlock their Smartphone throughout their exercise session.

The display of the information on the wearable display device to the user during the exercise session might be in graphical format or text format. The data may also be stored for future processing or transfer either by the wearable display device or the user's mobile device for the purposes of sharing or sending data to cloud based exercise tracking systems or other 3^{rd} party platforms such as health insurance providers. While it has been mentioned that the wearable display device might require the presence of a mobile device such as a Smartphone to analyze and process the sensed data, it can be appreciated that the wearable display device may be able to support all of the functionality the mobile device might have, allowing for only a single device to practice the invention.

In other embodiments, the invention as it relates to fitness related activities, the wearable display device may also be able to scan the environment or physical objects around the user, where upon detection of items specific to a user's fitness regime, the wearable display device may be able to display instructive video, play instructive audio files, or display messaging. These may be triggered based on what the user was looking at through their wearable display device. For example, a person might walk up to an strength exercise machine and just by looking at the machine, information such as seat settings, weights settings, and how many reps the person should do for that workout may be displayed to the user on their wearable display device. Then, during the workout session on the same machine, the user's wearable display device is also monitoring and displaying the person's bio-metric data via the various sensors of the invention and using the inputs from these sensors to display motivational and instructional videos to the user. A video from a staff member might display saying ‘Come on, your heart rate is only at 110 bpm, push it!’, or a message might come up saying ‘if you finish your reps, you will earn a free smoothie’.

The invention can also use the multiple sensors to detect the motion/movement of either the person or the exercise machine/elements of an exercise machine a user is exercising on to also track and verify that exercise activity is in fact taking place (for example, a person using free weights can have the lifting of free weights detected by the optics in the wearable display device, allowing for a visual heads up display feedback to show a range of motion meter or form rating based on how the user is actually performing. This detection might occur when a person is standing in front of a mirror and the system uses the reflection to detect the motion, or the users is looking at the free weight and the system is automatically detecting changes in distances of the object(s) in motion during a workout.

Additionally, a strength type machine such as a LifeFitness Hammer Strenght Chest Press machine might have encoder based technology or force sensing type sensors that may transmit the real time motion of the weight stack which may be displayd to the user on their wearable device display during an exercise machine. As seen in the Koko Fitness Smarttrainer strength machine, machines like that that have a static display screen with sensors that detect weight stack movement and user guidance on the static display screen attached to the strength machine, this invention provides a better solution since any machine can now provide value to a user that is wearing their own personal wearable device that can display their own customized real time exercise instructions and real time results on the wearable device display without requiring the user to look in the direction of a static screen display.

The invention may be able to track the performance of the user and then allow the user to earn and collect points and rewards that were displayed to them via their wearable display device and then earned during their workout based on their performance.

Another example may be a user walking up to a cardio machine and just by looking at the control display of the machine, the user's wearable display device may highlight which buttons they should press to operate the machine. The user's wearable display device may be able to also monitor the user's performance while using the machine via the sensors types described earlier, or even be able to communicate directly with the exercise machine and control the machine based on the sensors. During the workout, if the user were to look at the machine's display console, the user's wearable display device may be able to show which buttons need to be pressed (example: speed up, incline up, etc). This may allow the user to have even more guidance from the invention by allowing real time monitoring of the user's performance and then prompting the user to operate the exercise machine by displaying instructions on what to do next.

A person might also look at an exercise machine and also be prompted that the machine is not working. The user's wearable display device (working with a mobile device) may be able to identify a broken machine by having a phone app communicate with a web server that might have listed that machine as broken. Additionally, the exercise machine might display a unique error code or even service QR code that the invention may be able to quickly decode through web searching which may come back with the appropriate display on the user's wearable display device. The content, such as media or messaging, that is displayed to the user on their wearable display device might exist on the user's associated mobile device or might be also be streamed for display using technologies such as augmented reality where the detection of images from the wearable display device's scanning camera may trigger the instant display of content that is stored either locally or remotely on a web server. This is advantageous over smartphone based augmented reality since a user constantly has to hold their mobile device over the image (as seen with apps like Layar). The invention may allow the user to effortlessly have content displayed to them simply by looking in the direction of an object that may trigger the display of said content.

Another aspect of the invention as it relates to fitness related activities is the ability to deliver exercise programming content to the user via the wearable display device. Examples of exercise programming content may be P90X types videos, Jillian Michaels workout videos, Spin Class instructional videos, Zumba, Pilates, Yoga, etc. In this instance, the content is specific to the person's performance as monitored by the invention during the exercise regime, and where the content is specific to the user's profile or workout regime. The invention can allow the user to follow a structured workout regimen where the content is delivered/displayed to the user, and adjusted (in real time feedback to the user during the workout). For example, a popular form of exercise in the home is done by using instructional video exercises that a person follows on the TV, computer, or tablet screen. This invention describes a better way to deliver exercise programming and instruction to a person by having content delivered to the user using audio, video, images, or a combination of at least two or more of these. Thus, as the user is working out, an image (or voice) of Jillian Michaels (or other motivator) could be communicated to the user to encourage the user to keep working. The motivator may be responsive to the condition of the user, the workout regime or any other parameter.

In this invention, Jillian Michaels or P90X exercise programming could be delivered to a user via a smartphone application that is in communication with or part of a person's wearable display device. This may allow a person to have instructional content delivered to them via audio and/or video/images that are displayed on the wearable display device while a person is working out. The wearable display device can use it's sensors to provide bio-metric feedback and activity feedback to the smartphone application, where the phone application may use the feedback to customize a next segment of the exercise regimen. The current system does not allow any customized ability since the traditional video delivery systems require the user to simply follow the regimen, with not ability to have feedback adjust their exercise instruction in real time. This invention solves that problem and allows exercise activity to be tracked and processed for further review by the system.

The invention may be able to track the user's intensity or performance from the structured programming and then grade them based on their performance. The system may also be able to generate points based on the level of adherence to the progressive instructive content, allowing the user to see where they measure up as it relates to the skill level required to continue on for the exercise program. This can also provide a level of safety since a person who is not performing well in P90X should not be encouraged to keep advancing to harder segments until they are informed they have met a performance threshold the system says is adequate.

Another aspect of the invention is related to creating a more immersive experience for a person that might be watching TV or watching a movie in a movie theater. For example, a group of people sitting in front of a TV all watching the same channel may be able to have a different experience based on the inventions ability to apply each person's individual bio-metrics, profile information (age, gender, etc) to the displayed content they may see on their own wearable display device. This may allow appropriate content to be filtered and displayed according to the various inputs each wearable display device is receiving from each person.

The value of this invention is immense since now there could finally be a solution that TV viewers could participate with that may allow them to learn more about products that are advertised to them on commercials. Additionally, the invention may also be able to provide a completely un-tapped inventory of marketing and advertising inventory since the person's wearable display device is not only operating as another viewing screen, but more importantly is providing the ability to close the loop and provide user analytics back to advertisers and content providers. For example, the invention may be able to tracking how long a person is watching a channel, what channel they are watching (using image recognition, voice recognition, etc) and then share that information along with specific user info: John Smith watch Fox news for 35 minutes, CNN for 12 minutes, and NBA Basket ball for two hours on MM/DD/YYYY.

The invention can also provide a novel method for how tv based products are purchase (such as QVC type products). Instead of calling in or logging onto a website such as is done with QVC, a person wearing their wearable display device can get more information on products that they are viewing on their TV screen and then use their touchpad interface or voice controls to purchase the products. Their wearable device (or connected mobile device) can authenticate the user via a software application that recognizes the person, or by using a fingerprint scan that might happen on the mobile device or the wearable display device hardware.

The invention may also allow the user to physically interact with the wearable display device which might allow the user to be prompted to share content that is being displayed to them via their wearable display device by pressing a button or interface on their device that may send content to one of their linked services such as email lists, social media feeds, etc. This may allow the user to share information or products, and possibly be rewarded by big brands for doing so by tying the system into points systems.

The invention may also allow a person watching TV to have personalized content displayed to them via their wearable display device that is based at least one bio-metric sensor input. For example, a person who is over weight might not know they have diabetes. However, if they are sitting on the couch (or even in front of a computer screen while on the internet) for a prolonged period of time, they might have diabetes product related information displayed to them based on the inventions ability to detect user profile info (weight, age, sex), and/or real time heart rate/pulse, etc. The wearable display device might also have a ‘buy’ button on the device which may allow them to purchase the device immediately. Additionally, the lack of movement from the user by sitting around too long might prompt a message to be displayed to them on their wearable display device such as ‘Time to move! Go for a walk or ride a bike!’.

The wearable display device of the invention might be in any form that may be worn by a person that is capable of having at least one electronic display screen (on the wrist, forearm, leg, head, etc). The mobile device can be at least one of a Smartphone, feature phone, tablet, iPad, Android, Netbook, Laptop, personal PC, smart watch device like Basis Band, accelerometer based devices such as those provided by Nike (Fuel Band, GPS Watch, etc).

The communication between the wearable display device and the mobile device can be at least one of a hardwired connection or one of a wireless connection. The invention can also be applied to delivering personalized interactive content and instructive media in applications such as education, manufacturing environments (assembly work instructions, quality control and inspection of parts and assemblies, machine set up instructions), automotive/aerospace repair, and entertainment and media industries.

In should be appreciated that the invention as disclosed herein may be implemented as desired via any devices suitable to the desired end purpose, such as digital devices, analog devices and/or a combination of digital and analog devices. Additionally, although the invention is disclosed herein with regards to one device, it is contemplated to be within the scope of the invention that a plurality of devices may be connected together (or integrated together) to achieve the same or similar results.

In accordance with the present invention, the processing of the invention may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

Moreover, the method of the present invention may be embodied in the form of a computer or controller implemented processes. The method of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims and/or information. Moreover, unless specifically stated any use of the terms first, second, etc. do not denote any order or importance, but rather the terms first, second, etc. are used to distinguish one element from another.

1-5. (canceled)

6. A wearable electronic display device, comprising:
a bio-metric sensor, wherein the bio-metric sensor is configured to,
sense a bio-metric characteristic of a user, and
generate bio-metric user data responsive to the bio-metric characteristic;
communication circuitry configured to wirelessly communicate with an exercise device, wherein the communication circuitry is configured to at least one of,
send the bio-metric user data to the exercise device, and
receive, from the exercise device, at least one of exercise machine data and exercise device user performance data; and
a processing device, wherein the processing device is configured to,
process at least one of the bio-metric user data, exercise machine data and exercise machine user performance data to generate processed data, and
control the display of the wearable electronic display device during a workout regime responsive to the processed data.

7. The wearable electronic display device of claim 6, wherein the wearable electronic display device is at least one of a smartwatch device, an accelerometer device, a head mounted frame device, a mobile device, a smartphone and an eyeglass device.

8. The wearable electronic display device of claim 6, wherein the bio-metric sensor is at least one of a heart rate sensor, a blood pressure sensor, a body fat sensor, a body temperature sensor, an accelerometer sensor, a sweat sensor, a pulse oximeter sensor and a blood glucose sensor.

9. The wearable electronic display device of claim 6, wherein the exercise machine data includes at least one of exercise device type, exercise machine software state data, exercise program data, distance, speed, incline, resistance, stride, channel setting, volume setting, TV/media information, and weight setting.

10. The wearable electronic display device of claim 6, wherein the exercise machine user performance data includes at least one of calories burned, distance, speed, heart rate and repetitions.

11. The wearable electronic display device of claim 6, wherein the exercise device is at least one of a cardio exercise training machine and a strength exercise training machine.

12. The wearable electronic display device of claim 6, wherein at least one of,
the communication circuitry is at least partially integrated with the wearable electronic display device, and
the wearable electronic display device is in further communication with an external device which is configured to generate at least a portion of the processed data.

13. The wearable electronic display device of claim 6, wherein at least one of the exercise machine data and the exercise machine user performance data is received is from at least one of an exercise machine memory, a peripheral processing device that is in communication with the exercise device, an encoder sensor configuration configured to measure the movement of an exercise device, a force sensing sensor that measures the movement of an exercise device and a sensor that can detect the movement of an element of an exercise device.

14. The wearable electronic display device of claim 6, wherein the wearable electronic display device includes software that is configured to receive exercise machine software state data of the exercise device and use the exercise machine software state data to trigger messaging for display on the wearable electronic display device.

15. A system for associating a user with an exercise device via a wearable electronic display device, comprising:
an exercise machine configured for wireless communication, wherein the exercise machine is configured to generate at least one of exercise machine data and exercise machine user performance data;
a wearable electronic display device having a processing device, wherein the wearable electronic display device includes a bio-metric sensor configured to sense a bio-metric characteristic of a user, and generate bio-metric user data responsive to the bio-metric characteristic, wherein the wearable electronic display device is configured for wireless communication,
wherein at least one of,
the exercise machine is configured to transfer at least one of the exercise machine data and the exercise machine user performance data to the wearable electronic display device, and
the wearable electronic display device is configured to transfer bio-metric user data to the exercise machine; and
wherein the processing device is configured to control the display of the wearable electronic display device responsive to at least one of the exercise machine data, the exercise machine user data and the bio-metric user data.

16. The system for associating a user with an exercise device via a wearable electronic display device of claim 15, wherein the wearable electronic display device is at least one of a smartwatch device, an accelerometer device, a head mounted frame device, a mobile device, a smartphone and an eyeglass device.

17. The system for associating a user with an exercise device via a wearable electronic display device of claim 15, wherein the bio-metric sensor is at least one of a heart rate sensor, a blood pressure sensor, a body fat sensor, a body temperature sensor, an accelerometer sensor, a sweat sensor, a pulse oximeter sensor and a blood glucose sensor.

18. The system for associating a user with an exercise device via a wearable electronic display device of claim 15, wherein the exercise machine data includes at least one of exercise device type, exercise machine software state data, exercise program data, distance, speed, incline, resistance, stride, channel setting, volume setting, TV/media information, and weight setting.

19. The system for associating a user with an exercise device via a wearable electronic display device of claim 15, wherein the exercise machine user performance data includes at least one of calories burned, distance, speed, heart rate and repetitions.

20. The system for associating a user with an exercise device via a wearable electronic display device of claim 15, wherein the exercise device is at least one of a cardio exercise training machine and a strength exercise training machine.

21. A method for associating a wearable electronic display device with an exercise device,
the method comprising;
establishing a bi-directional wireless communication link between the wearable electronic display device and the exercise device, wherein the exercise device is configured to generate at least one of exercise machine data and exercise machine user performance data, and wherein the wearable electronic display device includes at least one bio-metric sensor configured to generate bio-metric user data;
communicating at least one of,
the bio-metric user data to the exercise device, and
at least one of the exercise machine data and exercise machine user performance data to the wearable electronic display device;
processing at least one of the bio-metric user data, the exercise machine data, and the exercise machine user performance data to generate processed data; and
configuring the wearable electronic display device to display at least one of the processed data, the bio-metric user data, the exercise machine data, and the exercise machine user performance data.

22. The method of claim 21, wherein the wearable electronic display device is at least one of a smartwatch device, an accelerometer device, a head mounted frame device, a mobile device, a smartphone and an eyeglass device.

23. The method of claim 21, wherein the bio-metric sensor is at least one of a heart rate sensor, a blood pressure sensor, a body fat sensor, a body temperature sensor, an accelerometer sensor, a sweat sensor, a pulse oximeter sensor and a blood glucose sensor.

24. The method of claim 21, wherein the exercise machine data includes at least one of exercise device type, exercise machine software state data, exercise program data, distance, speed, incline, resistance, stride, channel setting, volume setting, TV/media information, and weight setting.

25. The method of claim 21, wherein,
the exercise machine user performance data includes at least one of calories burned, distance, speed, heart rate and repetitions; and
the exercise device is at least one of a cardio exercise training machine and a strength exercise training machine.
